(19) United States
(12) Patent Application Publication
(10) Pub. No.: US 2018/0090125 A1
(43) Pub. Date: Mar. 29, 2018

(54) SIMULATION OF DRIVING SOUND OF ELECTRIC VEHICLE

(71) Applicant: Yung Yeung, Pasadena, CA (US)

(72) Inventor: Yung Yeung, Pasadena, CA (US)

(21) Appl. No.: 15/715,309

(22) Filed: Sep. 26, 2017

Related U.S. Application Data
(60) Provisional application No. 62/399,759, filed on Sep. 26, 2016.

(51) Int. Cl. G10K 15/02; B60Q 5/00

(52) U.S. Cl. CPC G10K 15/02; B60L 2270/42; B60Q 5/008

(57) ABSTRACT

In an aspect of the disclosure, a method, a computer-readable medium, and an apparatus are provided. The apparatus may be a sound experience system in an electric vehicle. The sound experience system determines a list of sound profiles from one or more sound experience files. Each of the sound profiles specifies a plurality of sounds for providing a sound experience. The sound experience system receives an indication of a first sound profile from the list of sound profiles. The sound experience system further determines a condition of the electric vehicle; The sound experience system then selects a sound of the first sound profile based on the condition. The sound experience system generates a sound signal according to the selected sound.

### CROSS-REFERENCE TO RELATED APPLICATION(S)

This application claims the benefit of U.S. Provisional Application Ser. No. 62/399,759, entitled “SIMULATION OF DRIVING SOUND OF ELECTRIC VEHICLE” and filed on Sep. 26, 2016, which is expressly incorporated by reference herein in its entirety.

### BACKGROUND

### Field

The present disclosure relates generally to an electric vehicle, and more particularly, to techniques of simulating driving sounds of an electric vehicle.

### Background

Considerable developments have been made in the arena of electric vehicles (EVs). An EV can provide a driver with silent and smooth operations. However, there is a need to simulate a sound experience at the EV.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a sound experience system in an electric vehicle. The sound experience system determines a list of sound profiles from one or more sound experience files. Each of the sound profiles specifies a plurality of sounds for providing a sound experience. The sound experience system receives an indication of a first sound profile from the list of sound profiles. The sound experience system further determines a condition of the electric vehicle; The sound experience system then selects a sound of the first sound profile based on the condition. The sound experience system generates a sound signal according to the selected sound.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a sound experience system in an EV.

FIG. 2 is a flow chart of a method (process) for operating a sound experience system in an EV.

FIG. 3 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The introduction of new electric vehicles (EVs) has befuddled many drivers because of silent and smooth operations of the EVs. Drivers are used to engine noises, gear shifting, throttle sounds, and the like. However, there is still a need for providing sound experiences to the drivers of the EVs.

Generally, the present disclosure is directed to a sound experience system in an EV. The sound experience system may bring a sound experience to an EV. The sound experience system can include sensors, computing systems, and mechanical/audio devices that operate together to acquire driving data with sensors, process the driving data with the computing systems, and then implement the traditional sound experience with the mechanical/audio devices.

In certain configurations, the sound experience can include a traditional driving sound. As such, the system can be configured to provide a traditional driving sound to the driver and passengers in an electric vehicle. The traditional diving sound can include for example, the sound of a fuel engine (e.g., gasoline, diesel, propane, natural gas, etc.) that matches the driving experience. That is, the sound emitted corresponds with the driving in acceleration, speed, gear shifting, or the like of a fuel engine being simulated by the sound experience system.

In certain configurations, the sound experience system may include sensors that can determine current driving conditions/scenarios/situations, and then provide corresponding audio sound to the driver. The sensors can include Global Positioning System (GPS) sensor, accelerometer, gyroscope, magnetometer, barometer, proximity sensor, light sensor, touch sensor, microphone, etc. The sensors can obtain driving data, such as acceleration or speed, analyze the driving data, and then determine the sound experience to be provided to the driver. Also, the sound experience system can provide sound data and/or sound signals to an audio system of the electric vehicle, which in turn generates the desired sound.

In one example, the sound experience system can be configured to simulate an automatic transmission fuel vehicle to provide the traditional sound experience. This embodiment can include the sound of an automatic transmission changing gears during acceleration. Also, this embodiment can include the sound of engaging an automatic transmission lever (e.g., which can be similar to the gear shift lever).

In another example, the sound experience system can be configured to simulate a manual transmission fuel vehicle to provide the traditional driving experience thereof. The sound experience system can simulate use of a clutch pedal and/or gear shift lever in the driving sound. For example, the lag of a clutch pedal being engaged can be heard and/or felt by the driver (even when there is no such clutch pedal). Similarly, the disengagement and engagement sound and feeling of a gear shift lever being operated can be heard and/or felt by the driver (even when there is no such gear shift lever).

In one example, the sound experience system can further simulate the sound of a fuel vehicle engine accelerating, which can include engine sounds, transmission sounds, exhaust sounds, or any other acceleration sounds of a fuel vehicle. This can provide a cognitive satisfaction to drive the electric vehicle that simulates the sound of the fuel vehicle during acceleration. This can be beneficial to drivers who learned or are/were used to traditional fuel engine vehicles. During the acceleration phase, the sound experience system can obtain data related to the acceleration and rate of acceleration from the sensors, so that the acceleration data can be processed by the computing system in order to identify simulated acceleration sound to be provided to the driver and passengers. The sound experience system can then provide the acceleration sound to the driver and passengers. Thus, the sound experience system can determine the acceleration of the electric vehicle and then provide the driving sound of the fuel vehicle. In one example, the sound experience system obtains the acceleration data from sensors in the mobile device and/or electric vehicle, and the acceleration data are processed in the application of the mobile device and/or electric vehicle, and the mobile device and/or electric vehicle provides the traditional driving sound simulation to the driver.

In one example, the sound of a fuel vehicle, such as the engine, transmission, and/or exhaust, can be provided to simulate the traditional driving experience. The simulation can be through various accelerations and acceleration rates, gear changes, and lag or decelerations that may be experienced in a fuel vehicle.

In one example, the sound experience system can provide a traditional driving experience of any type of vehicle. That is, the type of traditional driving experience simulation can be selected, and the traditional driving experience of that type will be simulated. Accordingly, the sound experience system can include a database that has traditional driving experience simulation data for a range of vehicles. In one embodiment, different general types of vehicles can be simulated, such as sub-compact, compact, medium, sedan, sports cars, SUV, trucks, industrial vehicles, garbage trucks, dump trucks, semis, tractors, go-carts, ATV, UTV, motorcycle, or any other. The different types can also include different types of engines, such as 4-cylinder, boxer, V-6, 1-6, V8, V-10, rotary, diesel, propane, natural gas, turbo charged, supercharged, nitrocharged, motorcycle engines, 4-stroke, 2-stroke, V-twins, combination thereof, or any other. That is, the electric vehicle can provide the traditional driving experience of any type of vehicle even if it is different from the electric vehicle being driven. The driving experience data for sound can be obtained for any type of vehicle, and processed by the computing system, utilized so that the desired traditional driving experience can be obtained. In additional, the driving acceleration and speed of the electric vehicle can be provided to match and simulate any of these types of vehicles or engines. As such, the database can include a list of the different types of vehicles or engines that can be simulated in the electric vehicle, and a selection can be made. Then, the electric vehicle will actually drive like that vehicle as well as sound like that vehicle. In an example, a dump truck vehicle can be selected with a diesel engine, and the electric vehicle can start, engage, drive, and brake like such a dump truck, which is usually slow and cumbersome. The simulation may also include simulated raising or lowering a fictional dump bed upon activating a selection. A graphical user interface, such as a touch screen, can be interacted with in order to make selections and to obtain secondary features, such as dump bed raising and lowering. In another example, the same electric vehicle can be used with a sports car selected, and the electric vehicle can drive, sound, and feel like a sports car. This can give a driver the satisfaction of selecting the driving mode to match a certain vehicle. Additionally, certain kinds of cars, such as Ferrari, Lamborghini, Lotus, and the models thereof can be selections for the vehicle type. In one instance, a bullet bike or cruzer motorcycle simulation can be used for the electric car vehicle.

In one example, the sound experience system can be configured for any type of electric vehicle, ranging from electric cars, trucks, motorcycles, or any other. In one example, the driving type can be selected in the sound experience system. That is, the type of driving from slow and casual to fast and furious can be selected and the electric vehicle will perform to that type of driving as well as provide the sound of that type of driving. In one example, various driving parameters can be selected.

The parameters can be peek RPMs, or RPMS where a turbo or supercharger or nitrocharger kicks in.

In one example, the sound experience system may include a sensor to measure electric motor speed (RPM) and/or car speed. The systems and methods can also include hardware and software mechanisms to create audio sounds over the vehicle Hi-Fi stereo or other speaker or even through a mobile device. The system can pitch shift the audio according of an actual fuel engine vehicle to simulated fuel engine RPM to the electric vehicle. The sound experience system can obtain driving data from the sensors so that the driving style can be analyzed and a corresponding traditional driving experience simulation can be output. For example, the sensors can include a GPS sensor for speed, and an accelerometer for cornering and acceleration. For example, during hard driving and turning the sound experience system can provide simulated tire screeching even when the tires are not actually screeching.

In one example, the sound experience system can be used to provide a traditional driving experience to electric cars, by adding realistic engine noises, gearshifts, vibrations and other similar “vintage” characteristics of traditional gasoline or diesel-powered vehicles, into a modern electric vehicle. Sensory feedback is provided to the driver and passengers of an electric vehicle or other non-traditional car, to greatly enhance the driving experience by reminding the driver cognitively of a traditional gasoline or diesel-powered driving experience, providing comfort, enjoyment and higher marketable value for a car when equipped with the sound experience system.

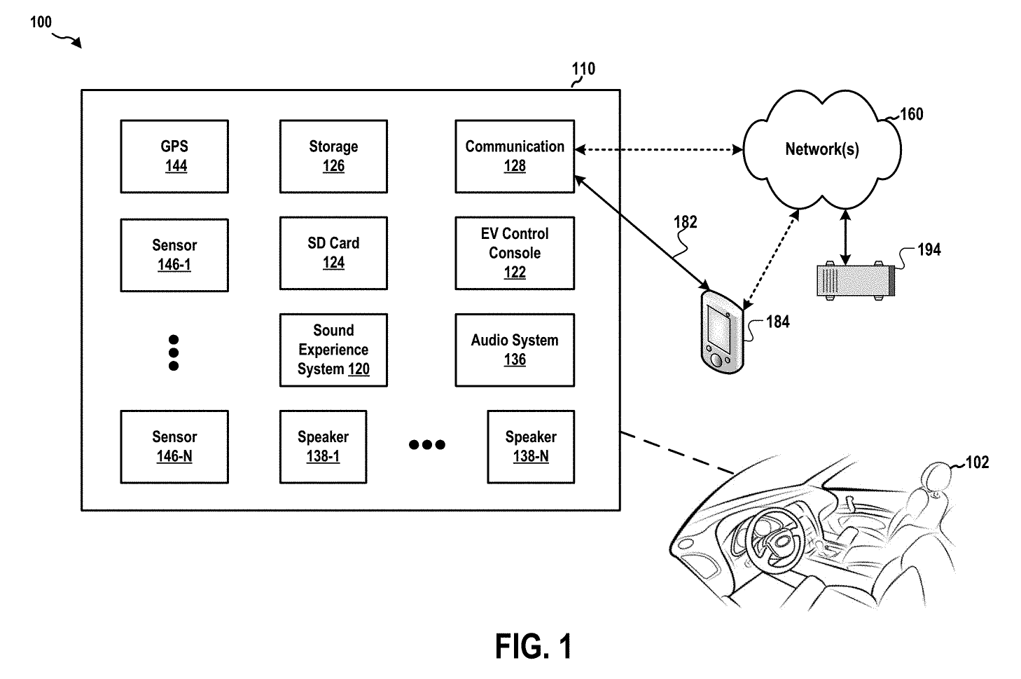

FIG. 1 is a diagram 100 illustrating a sound experience system in an EV. An EV 102 has an electronic system 110. The electronic system 110 includes, among other components, a sound experience system 120, an EV control console 122, a (Secure Digital) SD card component 124, a storage 126, a communication component 128, an audio system 136, speakers 138-1 . . . 138-N, a GPS sensor 144, and sensors 146-1 . . . 146-N.

In one example, the storage 126 stores various sound experience files. The sound experience files contain data of a list of sound profiles. Each of the sound profiles specifies a series of sounds for providing a sound experience. The sound experience system 120 can retrieve one or more of the sound experience files from the storage 126 and can generate sound signals according to the sound experience files. The sound experience system 120 then sends the sound signals to the audio system 136, which in turn drives the speakers 138-1 . . . 138-N to play the sound, thus generating the desired sound experience for the driver of the EV 102. As described supra, the sound files stored in the storage 126 can cause the sound experience system 120 to generate, according to sound profiles, sound signals simulating sounds of cars such as AMG(R), FERRARI(R), LAMBORGHINI(R), LOTUS(R), etc. The speakers 138-1 . . . 138-N can play the sounds accordingly.

In certain configurations, the sound experience system 120 detects the available sound experience files stored in the storage 126. Based on those sound experience files, the sound experience system 120 can generate a first list of sound profiles available to provide sound experiences in the EV 102. The sound experience system 120 can generate and display an interface on the EV control console 122, which may include a touch screen. The interface shows the list of available sound profiles. The interface also allows the driver of the EV 102 to select one or more of the available sound profiles Based on the user selection, the sound experience system 120 retrieves the corresponding sound experience files from the storage 126 and generates the sound signals based on the retrieved sound experience files.

In certain configurations, the driver of the EV 102 can insert an SD card storing one or more sound experience files into the SD card component 124. The sound experience system 120 can detect the sound experience files stored in the SD card. Similar to what was described supra, the sound experience system 120 can generate a second list of sound profiles available to provide sound experiences in the EV 102 based on the sound experience files stored in the SD card. Accordingly, the interface of the EV control console 122 can display the second list of sound profiles in addition to, or instead of, the first list of sounds described supra.

In certain configurations, the communication component 128 is able to communicate with a network device 194 through a network 160. For example, the communication component 128 may include a Long-Term Evolution (LTE) modem or other cellular communication components and the network 160 may be a wireless wide area network (WWAN) network. In another example, the communication component 128 may include a Wi-Fi component and the network 160 may be a Wi-Fi network. The network device 194 may include one or more of sound experience files. The sound experience system 120 may inquire the network device 194 about the sound experience files stored on the network device 194. As such, the sound experience system 120 may generate a third list of sound profiles based on the sound experience files stored on the network device 194. Accordingly, the interface of the EV control console 122 can display the third list of sound profiles in addition to, or instead of, the first list of sounds described supra. Once the driver selects one or more sound profiles from the third list, the sound experience system 120 can retrieve the corresponding sound experience files from the network device 194 and generates sound signals.

In certain configurations, the sound experience files can be generated by recording the sounds of various models of cars. In certain configurations, the sound experience files can be generated by using a computer to simulate the sounds of various models of cars.

In certain configurations, the EV control console 122 may also include a voice activation component. The voice activation component can use the audio system 136 to announce the first list, the second list, and/or the third list of available sound profiles to the driver of the EV 102. The voice activation component then can recognize the driver's voice commands for selecting one or more of the listed sound profiles. The sound experience system 120 can retrieve the corresponding files from the network device 194 and generates sound signals based on the user selections.

In certain configurations, the communication component 128 may be able to communicate with a mobile device 184 (e.g., a smart phone) of the driver through a communication link 182 (e.g., a BLUETOOTH communication link). The mobile device 184 may have an application that provide a user interface. The user interface may show available sound profiles from the first list, the second list, and/or the third list.

In one configuration, the mobile device 184 may establish the communication link 182 with the sound experience system 120 through the communication component 128. As described supra, the sound experience system 120 can determine the sound experience files available at the storage 126 and, if provided, the SD card component 124 and the network device 194. Based on the sound experience files available on the storage 126, the SD card component 124, and the network device 194, the sound experience system 120 can generate the first list, the second list, and the third list, respectively. Further, the sound experience system 120 can send one or more messages to the mobile device 184, the messages including indications of those available sound experience files. The communication interface of the mobile device 184 receives the messages and may forward the messages to a corresponding sound experience APP on the mobile device 184. The sound experience APP can process the messages, extract the names of the available sound profiles, and display those names on the user interface of the mobile device 184.

The interface also allows the driver of the EV 102 to select one or more sound profiles displayed there to indicate one or more of the available sound profiles to be utilized at the sound experience system 120. Upon receiving the user's selections, the sound experience APP on the mobile device 184 can send, to the sound experience system 120, a message indicating the user's selection. The sound experience system 120 can determine the sound profile selected by the user and can, accordingly, retrieve the corresponding sound experience files from the storage 126, the SD card component 124, and/or the network device 194, as described supra. As such, the sound experience system 120 can use those sound experience files to produce a sound experience desired by the user.

In another configuration, the electronic system 110 (in particular, the communication component 128) may not be in communication with the network 160. The mobile device 184, however, is in communication with the network 160. The mobile device 184 may communicate with the network device 194 to retrieve indications of all the sound experience files available on the network device 194. Further, the user interface of the sound experience APP may present one or more categories of the car sounds. For example, the user interface may show a sports-car category, a classic-car category, etc. The user may select one or more interested categories. The sound experience APP then sends, to the network device 194, a message including indications of the user interested categories. Upon receiving the message, the network device 194 can select the sound experience files associated with sound profiles that fall into the categories selected by the user. The network device 194 then send, to the mobile device 184, one or more messages that include indications of the selected sound experience files.

Upon receiving the messages from the network device 194, the sound experience APP can generate a list including the sound profiles available at the network device 194. The sound experience APP then displays the list on the user interface. Similarly to what was described supra, the user can select one or more sound profiles. The sound experience APP sends one or more requests to the network device 194 to retrieve the sound experience files associated with the selected sound profiles. As such, the sound experience APP can store those sound experience files locally on the mobile device 184.

As described supra, the mobile device 184 may subsequently establish communication with the communication component 128 through the communication link 182. The sound experience APP can send a message to the sound experience system 120 to inform the sound experience system 120 that the mobile device 184 has sound experience files locally stored. The sound experience system 120 accordingly can obtain those sound experience files from the mobile device 184.

As described supra, in this example, the electronic system 110 includes the GPS sensor 144 and the sensors 146-1 . . . 146-N. The sensors 146-1 . . . 146-N may include accelerometer, gyroscope, magnetometer, barometer, proximity sensor, light sensor, touch sensor, microphone, etc. In certain configurations, the sound experience system 120 can determine the location of the EV 102 based on the location data received from the GPS sensor 144. Further, the sound experience system 120 may include map data, and thus can determine the surroundings of the EV 102 at its current location based on the map data. Based on the location and the surroundings, the sound experience system 120 can select one or more sounds specified by the sound profile in use. Then the sound experience system 120 can retrieve, from a sound experience file, data corresponding to the selected sound and can generate the corresponding sound signals. In one example, based on the GPS data and the map data, the sound experience system 120 may determine that the EV 102 is traveling on a highway. Accordingly, the sound experience system 120 may select a sound of highway driving belonging to a sound profile (e.g., AMG(R) sound profile) selected by the driver of the EV 102. In another example, the sound experience system 120 can determine that the EV 102 is at an intersection. Accordingly, the EV 102 can select a sound that warns pedestrians who are crossing the intersection.

Further, based on the GPS data, the sound experience system 120 can also determine the speed of the EV 102 and select a sound suitable for the speed. In one example, the sound experience files stored in the storage 126, the SD card in the SD card component 124, or the network device 194 may indicate a suitable driving speed (e.g., a driving sound for at 40-49 miles per hour). The sound experience system 120 can select the suitable sound from the sound profile in use based on those indications.

In certain configurations, an accelerometer of the sensors 146-1 . . . 146-N can provide acceleration/deceleration data to the sound experience system 120. Based on the acceleration/deceleration data, the sound experience system 120 can select an acceleration/deceleration sound and retrieve the corresponding data from the sound experience file from the storage 126, the SC card in the SD card component 124, or the network device 194.

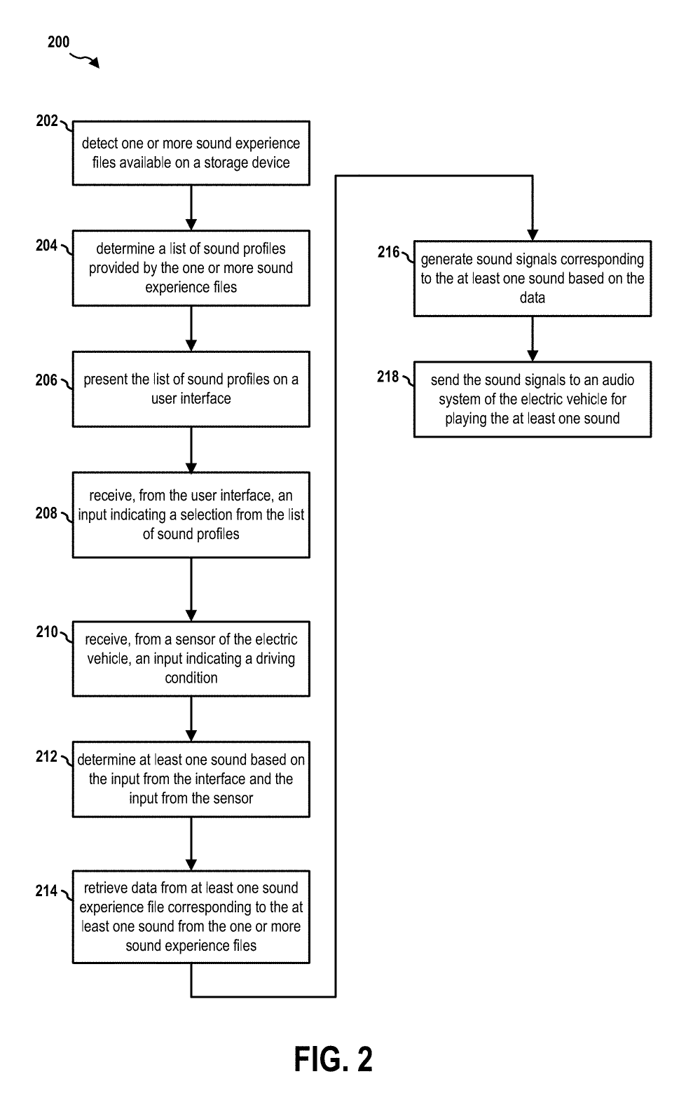

FIG. 2 is a flow chart 200 of a method (process) for operating a sound experience system in an EV. At operation 202, the sound experience system detects one or more sound experience files available on a storage device. At operation 204, the sound experience system determines a list of sound profiles (e.g., sports car sound profiles, classic car sound profiles, etc.) provided by the one or more sound experience files. At operation 206, the sound experience system presents the list of sound profiles on a user interface. At operation 208, the sound experience system receives, from the user interface, an input indicating a selection from the list of sound profiles (e.g., the AMG(R) sound profile). At operation 210, the sound experience system receives, from a sensor of the electric vehicle, an input indicating a driving condition.

At operation 212, the sound experience system determines at least one sound based on the input from the interface (e.g., selected AMG(R) sound profile) and the input from the sensor (e.g., high speed traveling). At operation 214, the sound experience system retrieves data from the at least one sound experience file corresponding to the at least one sound from the one or more sound experience files. At operation 216, the sound experience system generates sound signals corresponding to the at least one sound (e.g., high speed sports car traveling sound) based on the data. At operation 218, the sound experience system sends the sound signals to an audio system of the electric vehicle for playing the at least one sound.

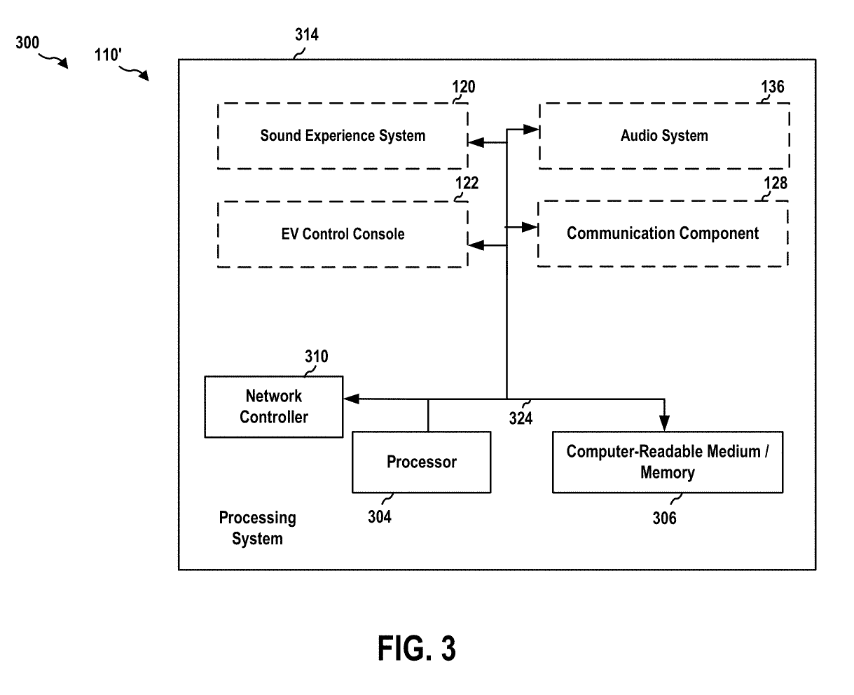

FIG. 3 is a diagram 300 illustrating an example of a hardware implementation for an apparatus 110′ employing a processing system 314. The apparatus 110′ may implement the electronic system 110. The processing system 314 may be implemented with a bus architecture, represented generally by the bus 324. The bus 324 may include any number of interconnecting buses and bridges depending on the specific application of the processing system 314 and the overall design constraints. The bus 324 links together various circuits including one or more processors and/or hardware components, represented by the processor 304, the sound experience system 120, the audio system 136, the EV control console 122, the communication component 128, and the computer-readable medium/memory 306. In particular, the computer-readable medium/memory 306 may include the memory 114 and the storage 126. The bus 324 may also link various other circuits such as timing sources, peripherals, voltage regulators, and power management circuits, which are well known in the art, and therefore, will not be described any further.

The processing system 314 may be coupled to a network controller 310. The network controller 310 provides a means for communicating with various other apparatus over a network. The network controller 310 receives a signal from the network, extracts information from the received signal, and provides the extracted information to the processing system 314, specifically a communication component 128 of the apparatus 110′. In addition, the network controller 310 receives information from the processing system 314, specifically the communication component 128, and based on the received information, generates a signal to be sent to the network. The processing system 314 includes a processor 304 coupled to a computer-readable medium/memory 306. The processor 304 is responsible for general processing, including the execution of software stored on the computer-readable medium/memory 306. The software, when executed by the processor 304, causes the processing system 314 to perform the various functions described supra for any particular apparatus. The computer-readable medium/memory 306 may also be used for storing data that is manipulated by the processor 304 when executing software. The processing system further includes at least one of the sound experience system 120, the audio system 136, the EV control console 122, the communication component 128. The components may be software components running in the processor 304, resident/stored in the computer readable medium/memory 306, one or more hardware components coupled to the processor 304, or some combination thereof.

The apparatus 110′ may be configured to include means for performing each of the operations described supra referring to FIG. 2. The aforementioned means may be one or more of the aforementioned components of the apparatus 110 and/or the processing system 314 of the apparatus 110′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operating a sound experience system of an electric vehicle, comprising:
determining a list of sound profiles from one or more sound experience files, wherein each of the sound profiles specifies a plurality of sounds for providing a sound experience;
receiving an indication of a first sound profile from the list of sound profiles;
determining a condition of the electric vehicle;
selecting a sound of the first sound profile based on the condition; and
generating a sound signal according to the selected sound.

2. The method of claim 1, further comprising:
sending the sound signal to an audio system of the electric vehicle for playing a sound.

3. The method of claim 1, further comprising:
detecting the one or more sound experience files on a storage device of the sound experience system, a network storage device, or a mobile device.

4. The method of claim 3, further comprising:
retrieving, at the mobile device, the one or more sound experience files from the network storage device through a network;
determining, at the mobile device, a first sound experience file of the one or more sound experience files, the first sound experience file containing data of the first sound profile; and
sending, at the mobile device, the first sound experience file to the sound experience system.

5. The method of claim 1, further comprising:
presenting, on a user interface, the list of sound profiles for user selection;
receiving a user input at the user interface; and
generating the indication of the first sound profile based on the user input.

6. The method of claim 5, wherein the user interface is on a mobile device, the method further comprising:
sending indications of the list of sound profiles to the mobile device.

7. The method of claim 1, further comprising:
receiving a sensor input from a sensor of the electric vehicle, wherein the condition is determined based on the sensor input.

8. A sound experience system of an electric vehicle, comprising:
a memory; and
at least one processor coupled to the memory and configured to:
determine a list of sound profiles from one or more sound experience files, wherein each of the sound profiles specifies a plurality of sounds for providing a sound experience;
receive an indication of a first sound profile from the list of sound profiles;
determine a condition of the electric vehicle;
select a sound of the first sound profile based on the condition; and
generate a sound signal according to the selected sound.

9. The sound experience system of claim 8, wherein the at least one processor is further configured to:
send the sound signal to an audio system of the electric vehicle for playing a sound.

10. The sound experience system of claim 8, wherein the at least one processor is further configured to:
detect the one or more sound experience files on a storage device of the sound experience system, a network storage device, or a mobile device.

11. The sound experience system of claim 10, wherein the at least one processor is further configured to:
retrieve, at the mobile device, the one or more sound experience files from the network storage device through a network;
determine, at the mobile device, a first sound experience file of the one or more sound experience files, the first sound experience file containing data of the first sound profile; and
send, at the mobile device, the first sound experience file to the sound experience system.

12. The sound experience system of claim 8, wherein the at least one processor is further configured to:
present, on a user interface, the list of sound profiles for user selection;
receive a user input at the user interface; and
generate the indication of the first sound profile based on the user input.

13. The sound experience system of claim 12, wherein the user interface is on a mobile device, wherein the at least one processor is further configured to:
send indications of the list of sound profiles to the mobile device.

14. The sound experience system of claim 8, wherein the at least one processor is further configured to:
receive a sensor input from a sensor of the electric vehicle, wherein the condition is determined based on the sensor input.

15. A computer-readable medium storing computer executable code for a sound experience system of an electric vehicle, comprising code to:
determine a list of sound profiles from one or more sound experience files, wherein each of the sound profiles specifies a plurality of sounds for providing a sound experience;
receive an indication of a first sound profile from the list of sound profiles;
determine a condition of the electric vehicle;
select a sound of the first sound profile based on the condition; and
generate a sound signal according to the selected sound.

16. The computer-readable medium of claim 15, wherein the code is further configured to:
send the sound signal to an audio system of the electric vehicle for playing a sound.

17. The computer-readable medium of claim 15, wherein the code is further configured to:
detect the one or more sound experience files on a storage device of the sound experience system, a network storage device, or a mobile device.

18. The computer-readable medium of claim 17, wherein the code is further configured to:
retrieve, at the mobile device, the one or more sound experience files from the network storage device through a network;
determine, at the mobile device, a first sound experience file of the one or more sound experience files, the first sound experience file containing data of the first sound profile; and
send, at the mobile device, the first sound experience file to the sound experience system.

19. The computer-readable medium of claim 15, wherein the code is further configured to:
present, on a user interface, the list of sound profiles for user selection;
receive a user input at the user interface; and
generate the indication of the first sound profile based on the user input.

20. The computer-readable medium of claim 19, wherein the user interface is on a mobile device, wherein the code is further configured to:
send indications of the list of sound profiles to the mobile device.
